(19) United States
(12) Patent Application Publication
(10) Pub. No.: US 2016/0314416 A1
(43) Pub. Date: Oct. 27, 2016

(54) LATENT TRAIT ANALYSIS FOR RISK MANAGEMENT

(71) Applicant: International Business Machines Corporation, Armonk, NY (US)

(72) Inventors: Sinem Guven, New York, NY (US); Tsuyoshi Ide, Harrison, NY (US)

(21) Appl. No.: 14/693,965

(22) Filed: Apr. 23, 2015

(51) Int. Cl. G06Q 10/06

(52) U.S. Cl. CPC G06Q 10/0635; G06Q 10/06395

(57) ABSTRACT

According to one embodiment of the present invention, a method is provided in which a first ordinal data set is received and analyzed to construct one or more models that describe informativeness of data in the first ordinal data set in predicting a first measured outcome of one or more projects associated with the first ordinal data set. A second ordinal data set is received, and a second measured outcome of a project associated with the second ordinal data set is predicted based, at least in part, on the one or more models.

### BACKGROUND OF THE INVENTION

The present invention relates generally to the field of risk analysis systems, and more particularly to latent trait analysis systems for risk management.

Recent years have seen a major increase in the application of predictive analytics to the delivery of services, as more and more service providers rely on such analytics for proactive risk management. For example, in order to effectively manage project risks while ensuring high quality service delivery, service providers typically mandate a Quality Assurance (QA) process, where QA experts iteratively conduct risk assessment reviews in a solution design phase (i.e., prior to signing a contract and delivering services) to check the feasibility and the potential profitability of projects. At the pre-contract stage, identifying potential project risks accurately is of vital importance since it allows service providers to avoid profit erosion through proactive risk management.

Within the QA process, pre-defined and standardized questionnaires are used to cover various aspects of the business and technical risk factors for a given project. For each risk assessment question (or risk factor), qualified QA experts determine the answer (or risk level) based on their observations and expertise. For example, in information technology (IT) system development, questions may assess knowledge of customer requirements, encoded into a plurality of levels, where 1 represents “no risk,” and 5 represents “exceptionally high risk.”

### SUMMARY

According to one embodiment of the present invention, a method is provided comprising: receiving, by one or more computer processors, a first ordinal data set; analyzing, by one or more computer processors, the first ordinal data set to construct one or more models that describe informativeness of data in the first ordinal data set in predicting a first measured outcome of one or more projects associated with the first ordinal data set; receiving, by one or more computer processors, a second ordinal data set; and predicting, by one or more computer processors, a second measured outcome of a project associated with the second ordinal data set based, at least in part, on the one or more models.

According to another embodiment of the present invention, a computer program product is provided, comprising: one or more computer readable storage media and program instructions stored on the one or more computer readable storage media, the program instructions comprising: program instructions to receive a first ordinal data set; program instructions to analyze the first ordinal data set to construct one or more models that describe informativeness of data in the first ordinal data set in predicting a first measured outcome of one or more projects associated with the first ordinal data set; program instructions to receive a second ordinal data set; and program instructions to predict a second measured outcome of a project associated with the second ordinal data set based, at least in part, on the one or more models.

According to another embodiment of the present invention, a computer system is provided, comprising: one or more computer processors; one or more computer readable storage media; and program instructions stored on the one or more computer readable storage media for execution by at least one of the one or more processors, the program instructions comprising: program instructions to receive a first ordinal data set; program instructions to analyze the first ordinal data set to construct one or more models that describe informativeness of data in the first ordinal data set in predicting a first measured outcome of one or more projects associated with the first ordinal data set; program instructions to receive a second ordinal data set; and program instructions to predict a second measured outcome of a project associated with the second ordinal data set based, at least in part, on the one or more models.

### BRIEF DESCRIPTION OF THE DRAWINGS

FIG. 1 is a chart illustrating an example distribution of risk levels for each of a plurality of ratings in an example data set, in accordance with an embodiment of the present invention;

FIG. 2 is a plot illustrating an estimated distribution of a total risk level for an example data set, in accordance with an embodiment of the present invention;

FIG. 3 is a plot illustrating an item characteristic curve (ICC), in accordance with an embodiment of the present invention;

FIGS. 4A through 4F are plots illustrating item characteristic curves (ICCs) for a group of questions in an example data set, in accordance with an embodiment of the present invention;

FIG. 5 is a plot illustrating a distribution of latent project failure tendencies for a group of questions in an example data set, in accordance with an embodiment of the present invention;

FIG. 6 is a graph illustrating a comparison of failure prediction accuracies of different classification methods, in accordance with an embodiment of the present invention;

FIG. 7 is a functional block diagram of computing environment 100, in accordance with an embodiment of the present invention;

FIG. 8 is a flowchart illustrating operational steps for analyzing usefulness of an ordinal data set in predicting a measured outcome, in accordance with an embodiment of the present invention;

FIG. 9 is a flowchart illustrating operational steps for predicting a measured outcome based on an ordinal data set, in accordance with an embodiment of the present invention; and

FIG. 10 is a block diagram of internal and external components of the computer system of FIG. 7, in accordance with an embodiment of the present invention.

### DETAILED DESCRIPTION

Embodiments of the present invention recognize that since technology trends and business requirements can change significantly over time, it is of practical importance for QA experts to have enough knowledge of the informativeness of individual questionnaire items in terms of detectability of potential risks. This is generally a challenging task given the heterogeneity of individual risk items. Furthermore, when lacking a systematic approach to ensuring a minimum set of question items, QA questionnaires can tend to get more and more complex over time, resulting in prohibitive overhead.

Embodiments of the present invention provide solutions for quantitatively analyzing the informativeness of individual risk factors in questionnaires, while keeping high predictive accuracy for project health indicators. In this manner, embodiments of the present invention can be used to future project health in view of questionnaire results, as well as identify question items for questionnaires that are most likely to be informative of future project health. In one embodiment, a supervised latent trait analysis (sLTA) technique is used in conjunction with a weighted k nearest neighbor (k-NN) technique.

The following is a discussion of an exemplary embodiment of the present invention used in the context of contractual risk mitigation, in which QA assessment data is used for project health prediction. As will be apparent to those of ordinary skill in the art, embodiments of the present invention can be used in other contexts. For example, embodiments of the present invention may be used in healthcare, employee evaluation, academic tests, etc. Furthermore, embodiments of the present invention can be used generally to analyze usefulness of various ordinal data sets in predicting various measured outcomes.

I. Contractual Risk Mitigation Context

A. Contractual Risk Mitigation Process

In a typical contract risk management process during IT system development, a service provider starts with pre-bid consulting once a request-for-proposal is received from a potential customer. QA experts of the service provider can then assess both technical and business aspects of the new contract to fill out predefined questionnaires, with which various risk factors are identified as risk. If those risks are judged as impactful to the profitability after contract signature, corresponding risk mitigation actions are taken (e.g., modification of solution, negotiation on service level agreements and price) to remove the identified risk factors. Once the relevant risk factors are mitigated, the project goes to the stage of contract signing, followed by the service delivery phase. In the service delivery phase, project management reviews (PMR) are periodically conducted to check health metrics associated with the project.

B. Quality Assurance Questionnaire Data

In this embodiment, QA assessment data is taken as the input, and the project health indicator as the target. A questionnaire (e.g., contract risk assessment, or CRA) is used containing multiple (e.g., 22) qualitative questions about the project (e.g., relationship with customer, experience in the planned solution, completeness of the cost case, and feasibility of the schedule). Based on professional experience, QA experts can evaluate each of the factors with an integer number from one to five, with one being no risk and five being exceptionally high risk. Projects can go through multiple assessment-mitigation cycles. In an embodiment, focus is placed on the last CPI assessment as the input to the prediction model, denoted by x⁽ⁿ⁾ for the n-th project in the training data, as the n-th tends to reflect project risks right before contract signature.

After the contract signature, financial metrics are tracked on a periodic basis, and QA experts review the progress of the plan based on various additional information sources, including interviews with the delivery team. The project health indicator can include, for example, multiple sub-indicators, such as those on financial, technical, and project management statuses of the project. For illustrative purposes, embodiments of the present invention may be discussed with respect to one indicator related to the financial health (represented by one of A, B, C, D, based on business definitions), since financial heath is known to be a dominant indicator of project failures. In an embodiment, if the indicator falls in either C or D, the project is considered to be (financially) troubled. For illustrative purposes, the PMR with the worst financial health indicator can be taken as the target, which is denoted by y, and y takes the value of +1 when troubled (i.e., C or D), and −1 otherwise.

C. Characterizing Quality Assurance Questionnaire Data

In this embodiment, the QA data set includes many projects (e.g., several hundred), only a few of which (e.g., tens) have a troubled status. Focus is placed on questionnaire answers in a last assessment cycle, such that the majority of risk factors may have been already mitigated, and thus, there are may only be slight indications of risks in x⁽ⁿ⁾ that would not be readily comprehensible to human experts.

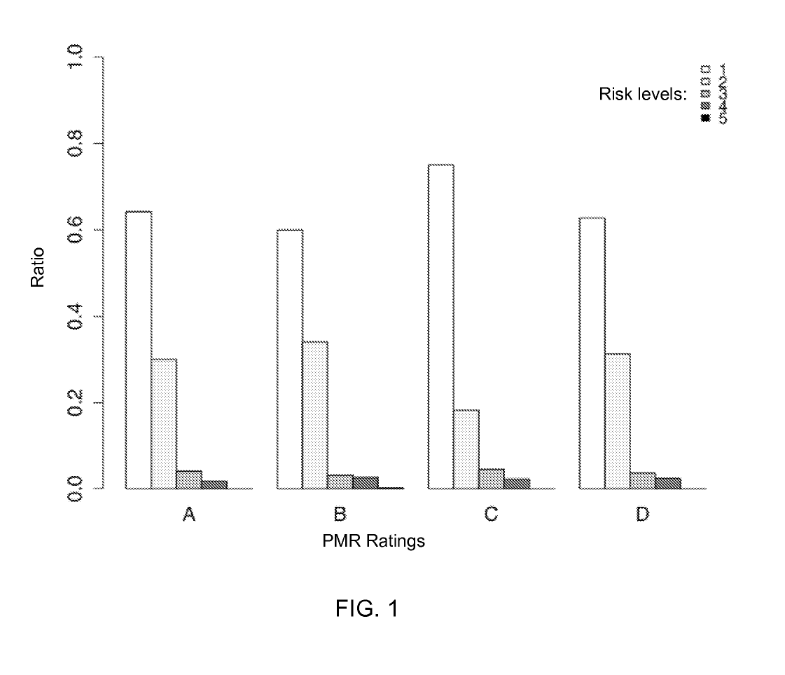

FIG. 1 illustrates an example distribution of risk levels for each of the PMR ratings (A, B, C, and D) in the example data set, in accordance with an embodiment of the present invention. As shown in FIG. 1, about 60% of the items are answered as 1 (no risk) irrespective of the PMR ratings. Furthermore, there is no clear trend that troubled projects get larger total risk levels.

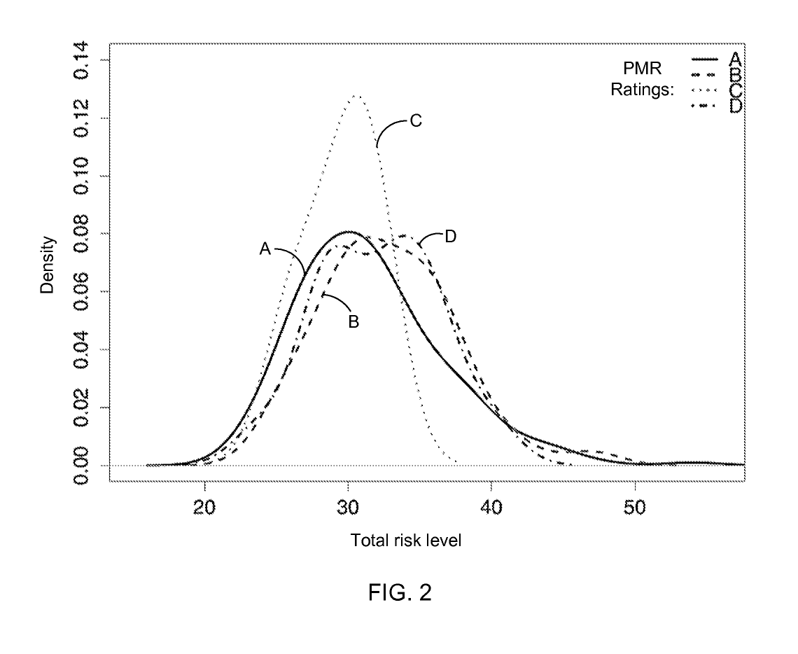

FIG. 2 illustrates and estimated distribution of the total risk level for the example data set, in accordance with an embodiment of the present invention. In this example, total risk level is defined by the summation of risk of questionnaire answers (e.g., 22 answers), calculated for all projects of the data set (e.g., 262 projects). In this embodiment, the RBF (radial basis function) kernel with the bandwidth 2 was used for density estimation. These features of the data clearly show the importance of the heterogeneity and the correlation among the individual risk factors to discriminate between healthy and troubled projects. Also of note is that the example data set is highly imbalanced in the sense that the majority of samples pertains to healthy projects. This can make naïve applications of existing machine learning technologies inappropriate for binary classification.

II. Latent Trait Analysis for Project Risk Analysis

A. Probability Distribution for at-Risk Answers

In this exemplary embodiment, a training data set can be represented by the following Equation:

[symbol]

={(x⁽ⁿ⁾,y⁽ⁿ⁾)|n=1,2, . . . ,N} (1)

where x⁽ⁿ⁾ is an M-dimensional vector representing the CRA questionnaire answers (e.g., M=22 where the questionnaire includes 22 question items), and y⁽ⁿ⁾ is the PMR health rating. Each of the dimensions of x⁽ⁿ⁾ takes an integer value in the predefined risk levels, while y⁽ⁿ⁾ takes either of +1 or −1 (i.e., troubled or healthy, respectively). The number of projects is denoted by N (e.g., N=262 where questionnaire answers are assessed over 262 projects).

As discussed below, this exemplary embodiment (and other embodiments) of the present invention provides a framework based on supervised latent trait analysis (sLTA) for quantifying the usefulness of each of the M inputs in terms of predictability of y, such that the indicator for usefulness can be readily understood by users (e.g., QA experts and project managers, who might not be experts in analytics).

In this exemplary embodiment, a project has a latent variable representing the tendency of project failure, denoted by a scalar variable θ. A project takes an assessment test consisting of M questions to yield a binary value for each question. For illustrative purposes and simplicity, analysis can be restricted to a single grade question, where +1 represents at-risk and 0 represents no-risk. This simplification can be clearly justified by the highly skewed distribution shown in FIG. 1 Error! Reference source not found. An “answer sheet” is represented by an M-dimensional binary vector xε{0,1}^{M}.

For each question (i.e., the i-th questions), the probability of being at-risk can be modeled according to the following modified version of a logistic function:

$$P ( θ , {a}_{i} , {b}_{i} , {c}_{i} ) ≡ {c}_{i} + \frac{1 - {c}_{i}}{1 + {e}^{- {a}_{i} ( θ - {b}_{i} )}} \qquad ( 2 )$$

where aᵢ, bᵢ, cᵢ are the model parameters of the i-th question and are typically called the discrimination, difficulty, and guessing parameters, respectively. The guessing parameter must satisfy the condition of 0≦cᵢ≦1.

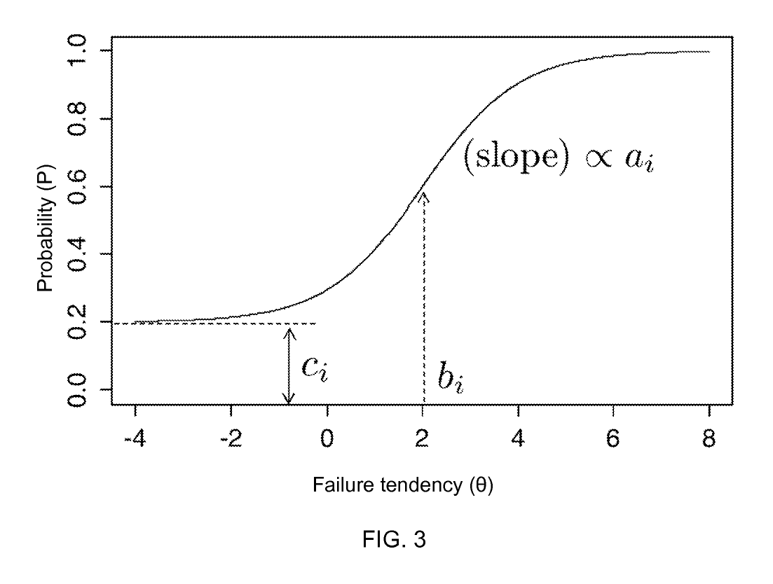

FIG. 3 depicts P as a function of θ (i.e., an item characteristic curve, or ICC), in accordance with an embodiment of the present invention. As shown in FIG. 3, since P is a monotonically increasing function of θ, as long as the discrimination parameter (aᵢ) is positive, the greater value of θ a project has, the more likely it is for the QA expert to choose the at-risk option, xᵢ=1. Also of note is that the nonlinear curve captures the bias of human review in which a person tends to be overly optimistic on the lower risk side while overly cautious on the higher risk side.

Additional insight can be gained from this model by considering the limit of θ→+∞. If the latent project failure variable goes to positive infinity, P takes the value of 1, meaning that xᵢ=1 holds with probability 1 (i.e., QA experts will choose the at-risk option if a project is evidently in trouble). If it goes to negative infinity, P goes to cᵢ. This means that for a given risk assessment question, the QA experts may choose the option of at-risk even if a project is completely healthy and its latent failure tendency is infinitely small. In this exemplary embodiment, the parameter cᵢ represents the possibility that QA experts use a random guess to fill out the questionnaire, or simply makes a mistake in doing so.

It is apparent that the difficulty parameter bᵢ plays a role of a threshold of risk. The probability P takes a value near 1 when θ−bᵢ is large. Thus, when bᵢ is large, only very risky projects having a large θ are allowed to take xᵢ=1. In this manner, the model allows automated threshold tuning for the individual question items.

The probability of an answer pattern x, which contains M answers given by a project having the latent failure tendency θ is given by:

p(x|θ,a,b,c)=Πᵢ₌₁^{M}P(θ,aᵢ,bᵢ,cᵢ)^{δ(x}^{ᵢ}^{,1)}×[1−P(θ,aᵢ,bᵢ,cᵢ)]^{δ(x}^{ᵢ}^{,0)} (3)

where δ represents Kronecker's delta; xᵢ is the answer to the i-th question; and a, b, c are defined as (aᵢ, . . . , a_{M})^{T} (bᵢ, . . . , b_{M})^{T}, and (cᵢ, . . . , c_{M})^{T}, respectively.

Although the model of Equation 3 resembles a modified version of logistic regression, the problem setting is different from supervised learning. The latent failure tendency θ is an unobserved latent variable, and what can be known is only how the QA experts answered the risk assessment questions for each of the projects. In estimating θ as well as the model parameters, a, b, c, based on a collection of answer sheets from N projects, the problem falls in the category of unsupervised learning.

B. Maximum a Posteriori Estimation for LTA Parameters

To capture the dispersion of the latent failure tendency, a typical LTA model assumes the standard Gaussian distribution as the prior distribution for θ, given by:

$$f ( θ \vert γ , ω ) = \sqrt{\frac{γ}{2}} exp \{ - \frac{γ}{2} {( θ - ω )}^{2} \} , \qquad ( 4 )$$

where γ and ω are hyper-parameters to be learned from the training data.

Following the Bayesian learning framework, given the data [symbol] , the unknown model parameters {a, b, c} are given as the maximum a posteriori (MAP) solution that maximizes the log marginal likelihood:

$$\begin{matrix} {max}_{a , b , c} L ( a , b , c \vert 𝒟 , ω , γ ) \\ subject to \\ 0 \leq {c}_{i} \leq 1 ( i = 1 , … , M ) , \\ where & ( 5 ) \\ L ( a , b , c \vert 𝒟 , ω , γ ) ≡ {\sum }_{n = 1}^{N} ln {\int }_{- ∞}^{∞} d {θ}^{( n )} f ( {θ}^{( n )} ) p ( {x}^{( n )} \vert {θ}^{( n )} , a , b , c ) . & ( 6 )\end{matrix}$$

Here, θ⁽ⁿ⁾ is the latent trait (or failure tendency) of the n-th project.

To handle the constraint on the guessing parameter, the method of barrier function can be used. Specifically, the marginal likelihood L can be replaced with the following objective function:

\tilde{L}(a,b,c [symbol] ,ω,γ)≡L(a,b,c| [symbol] ,ω,γ)+μ₁Σᵢ₌₁^{M} ln cᵢ+μ₂Σᵢ₌^{M} ln(1−cᵢ), (7)

and the unconstrained optimization problem can be solved using a known gradient method combined with a known line search for the step width. In this exemplary embodiment, μ=μ₁=μ₂ can be set, and the value can be determined by cross validation along with the hyper-parameter co.

C. Estimating Latent Failure Tendency

In this exemplary embodiment, once the MAP solution for the LTA parameters â,\hat{b},ĉ is obtained, the predictive distribution of the latent failure tendency θ for an arbitrary x is given by:

p(θ|x,â,\hat{b},ĉ)∝p(θ|γω)p(x|θ,\hat{x},â,\hat{b},ĉ). (8)

This is readily given by Bayes' theorem. However, the prior distribution is not conjugate to p(x|θ, x,â,\hat{b},ĉ). Accordingly, a point estimation for θ is made by choosing the value of the maximum probability density, represented as:

\hat{θ}=arg max_{θ}p(θ|x,â,\hat{b},ĉ). (9)

Considering the equation:

$$\frac{\partial }{\partial θ} = ln p ( θ \vert x , \hat{a} , \hat{b} , \hat{c} ) = 0 , \qquad ( 10 )$$

algebraic manipulation leads to the following fixed-point equation:

$$γ ( θ - ω ) = {\sum }_{i = 1}^{M} \frac{{\hat{a}}_{i} ( 1 - {\hat{c}}_{i} )}{1 + {e}^{- {\hat{φ}}_{i}}} \{ \frac{δ ( {x}_{i} , 1 )}{{\hat{c}}_{i} + {e}^{{\hat{φ}}_{i}}} + \frac{δ ( {x}_{i} , 0 )}{1 - {\hat{c}}_{i}} \} , \qquad ( 11 )$$

where \hat{φ}ᵢ ≡âᵢ(θ−\hat{b}ᵢ). Equation 11 can then be solved using any known numerical solver, or using iterative substitution between the left- and right-hand sides.

III. Project Failure Prediction Framework

A. Multiple Latent Variable Model

By solving Equation 9, a point estimate of \hat{θ} is calculated for an arbitrary x. Since θ is introduced as the latent failure tendency, one way to predict y is to use \hat{θ} as a surrogate of x. For example, when a new questionnaire answer x is provided, it can be translated into θ, and classification of y can be performed in the space of θ. In this exemplary embodiment, the classification is performed using the k-nearest neighbor (k-NN) method.

A practical issue of this approach is that questionnaires are typically designed to include multiple categories that are coupled with each other, and thus reducing x to a single scalar variable θ may risk oversimplification. For example, a QA questionnaire may include categories such as the quality of relationships among different parties (e.g., customer, subcontractors, internal teams, etc.) and the feasibility of technical solutions themselves.

In this exemplary embodiment, to capture such a hierarchical structure, the typical LTA framework is extended to include multiple latent variables. More specifically, the M question items of the questionnaire are partitioned into several disjoint groups [symbol] ₁, [symbol] ₂, . . . , [symbol] _{G}, and, instead of Equation 3, the following is assumed:

p(x|θ,a,b,c)=Π_{g=1}^{G}(x|θ_{g},a_{g},b_{g},c_{g}), (12)

where the g-th term is defined by:

p(x|θ_{g},a_{g},b_{g},c_{g})=Π_{lεM}_{_{g}}P_{g}(θ_{g},a_{g,l},b_{g,l},c_{g,l})^{δ(x}^{ᵢ}^{,1)}×[1−P_{g}(θ_{g},a_{g,l},b_{g,l},c_{g,l})]^{δ(x}^{ᵢ}^{,0)} (13)

The probability P of answering at-risk has been previously defined in Equation 2.

Corresponding to this partition, the prior distribution is also assumed to be partitioned accordingly:

f_{G}(θ|γω)=Π_{g=1}^{G}f(θg|γ,ω), (14)

where f(θ_{g}|γ,ω) on the right hand side is defined by Equation 4. In this exemplary embodiment, common hyper-parameters are used for simplicity.

In this exemplary embodiment, Equations 11 and 13 suggest an assumption of statistical independence between the partitioned groups. Making this assuming, the latent failure tendency is found by solving Equations 5 and 9 independently for each g, which results in a point-estimated G-dimensional latent variable \hat{θ}=(\hat{θ}₁, . . . , \hat{θ}_{G})^{T}.

B. Quantitative Measure of Question Item Informativeness

In this exemplary embodiment, ICCs can be used to calculate a quantitative measure for informativeness of question items. In the framework of sLTA described herein, one natural measure that can be used is the divergence between the probability distributions of xᵢ, conditional on y. An informativeness score of question i is given by:

sᵢ≡Div [p(xᵢ|y=+1, [symbol] )∥p(xᵢ|y=−1, [symbol] )], (15)

In this example, the questions can be approximately treated as binary response questions, which provides:

sᵢ=|p(xᵢ=1|y=+1, [symbol] )−p(xᵢ=1|y=−1, [symbol] )|, (16)

C. Failure Prediction

Based on the multiple latent variable model discussed above, a point estimation for the G-dimensional latent failure tendency \hat{θ} is obtained for an arbitrary x. As previously discussed to predict y for a new project having a questionnaire answer x, the k-NN method for failure prediction can be applied.

In this exemplary embodiment, to apply the k-NN method for failure prediction, k samples are first selected that are closest to the estimated θ in the latent failure tendency space. For the distance metric, the Euclidean distance is used as follows:

d(x,x⁽ⁿ⁾)=Σ_{g=1}^{G}w_{g}(\hat{θ}_{g}−\hat{θ}_{g}⁽ⁿ⁾)², (17)

where \hat{θ}_{g}⁽ⁿ⁾ is the point-estimated latent failure tendency for the g-th group of x⁽ⁿ⁾. w_{g} is included as the weight for the group g to handle prior knowledge on the relative importance between different item groups.

Once k-nearest neighbor samples are identified in [symbol] , the values of y of the selected samples can be checked. A decision score given by:

$$a ( x ) ≡ ln ( \frac{{N}_{+ 1}^{k}}{{N}_{- 1}^{k}} ) , \qquad ( 18 )$$

where N_{y}^{k} is the number of samples of the class of y in the nearest neighbors (NNs). If the decision score is greater than a specified threshold, the instance is classified into the y=+1 (i.e., troubled) class. One choice of the threshold is the log-ratio of the total number of positive samples (y=+1) to the total number of negative samples. Leave-one-out (LOO) cross validation (CV) can be used to further optimize the threshold. For example, several candidate values can be chosen, and a performance metric, such as f-value, can be calculated between the positive sample accuracy and the negative sample accuracy for each value. A threshold value can then be selected on the basis of achieving the best performance.

III. Example Experimental Data

A. Supervised Latent Trait Analysis (sLTA) Model

In this example, the example training data set (i.e., [symbol] ) includes a CRA questionnaire containing 22 questions (i.e., M=22) answered for 262 contracts (i.e., N=262). Based on predefined subcategories of CRA, the 22 question items were partitioned into four groups (i.e., G=4), which respectively correspond to (1) communication issues with the client, (2) how well-defined the scope of the project is, (3) the feasibility of the delivery plan, and (4) project management issues related to subcontractors and internal teams.

Given these inputs, Equation 5 and Equation 9 are solved using known techniques. The hyper-parameters are fixed as γ=1 and ω=0. In this example, no pre-selection of samples was made, and, as a result, the data is imbalanced in the sense that the majority of the projects are health (i.e., y=−1).

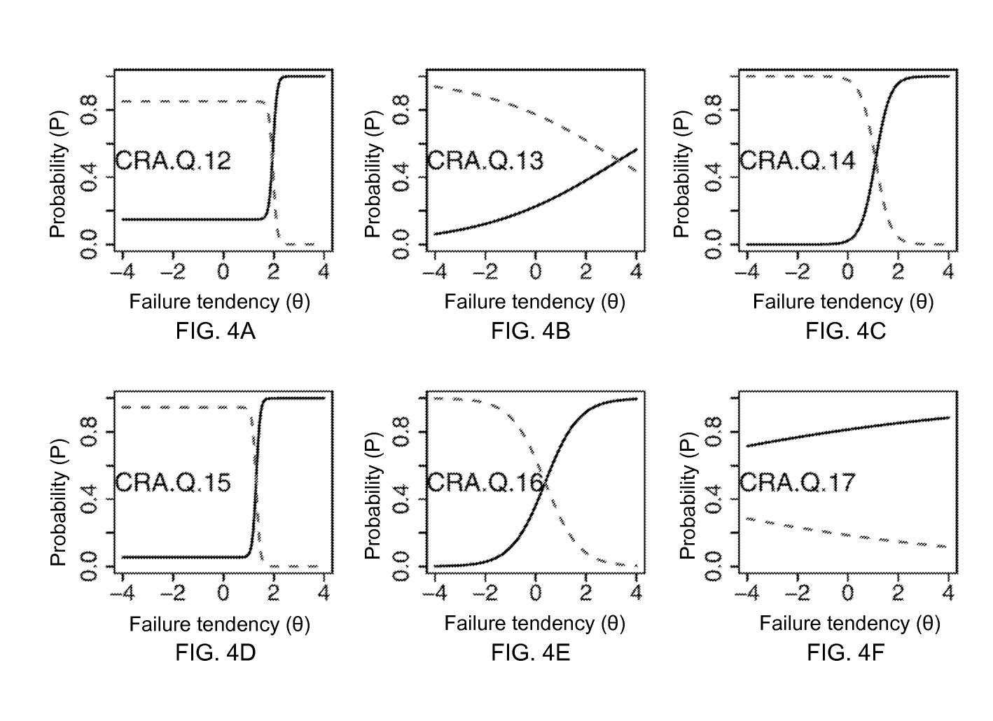

FIG. 4 illustrates item characteristic curves (ICCs) for a group of questions in the example data, in accordance with an embodiment of the present invention. Specifically, FIG. 4 illustrates ICCs for the group of g=3, which contains the 12^{th} through 17^{th} risk assessment questions. P(θ_{g},aᵢ,bᵢ,cᵢ) (i.e., the probability of answering at-risk) is drawn with solid lines, while 1−P(θ_{g},aᵢ,bᵢ,cᵢ) (i.e., the probability of answering no-risk) is drawn in dashed lines.

As shown in FIG. 4, the 17^{th} question is hardly useful to discriminate between the troubled and healthy statuses (i.e., lacks informativeness). In this example, this question is a formal question on service pricing and is expected to be less dependent on the quality of delivery plans. Also, the 12^{th} and 15^{th} question items are shown to be less sensitive indicators of project failure, in the sense that they “turn on” only for those evidently at-risk (i.e., become informative abruptly within a narrow range of 0 values). In contrast, the 14^{th} and 16^{th} question items are shown to be useful to pick up subtle indications of project failure. In this example, these questions ask about how clear and realistic the project plan is, and they are likely to effectively capture the risk of future project failure. In this way, it can be seen that the ICCs provide useful information on questionnaire design.

B. Latent Project Failure Tendency

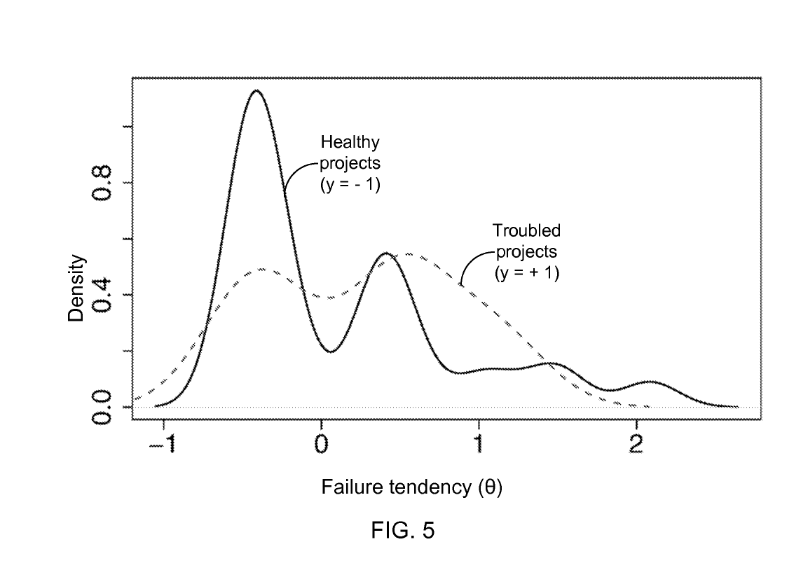

Based on the sLTA model discussed above and shown in FIG. 4, the latent project tendency θ_{g} for each of the samples in sample set D is calculated using Equation 11. The result is shown in FIG. 5, which shows the distribution of latent project failure tendency for the group g=3. Although Equation 10 gives point-estimated values {θ_{g}⁽¹⁾, . . . , θ_{g}^{(N)}}, kernel density estimation was performed using known techniques to capture the overall trend of θ_{g}. The bandwidth of the radial basis function (RBF) kernel was chosen as 0.18 and 0.32 for healthy (i.e., y=−1) and troubled (i.e., y=+1) projects, respectively.

As shown in FIG. 5, troubled projects tend to have more value of the latent failure tendency than healthy projects. Accordingly, using the nonlinear transformation provided by the sLTA model, θ can be an accurate indicator of project failure.

C. Health Indicator Prediction

To validate the sLTA model discussed above, the prediction accuracy on the binarized PMR financial project health indicator y can be evaluated. In this example, the performance was evaluated by the F-value defined by:

$$f = \frac{2 {r}_{1} {r}_{2}}{{r}_{1} + {r}_{2}} , \qquad ( 19 )$$

which is the harmonic mean between the prediction accuracy in the healthy projects, r₁, and the prediction accuracy in the troubled projects, r₂.

LOO CV was used to decide on the number of NNs (see subsection III(B)). For example, to check for a hit or miss for the n-th sample in the training data set [symbol] , that sample was held out from [symbol] , and the model was learnt from the remaining N−1 samples to make a prediction for that sample. The threshold value for a for the k-NN classification is fixed as the ratio of healthy samples to troubled projects.

In addition to the sLTA model disclosed herein, several other classification methods were evaluated for comparison, including: a k-NN classification in the x space (i.e., x-kNN); a logistic regression method in the x space (i.e., x-LR); the k-NN classification disclosed herein in the θ space (i.e., t-kNN) with a uniform weight (w_{g}=1 for g=1, . . . , 4); and the k-NN classification disclosed herein in the θ with a tuned weight (i.e., tw-kNN).

The x-kNN method used a baseline k-NN classification in the x space, where Equation 17 was replaced with the following:

d_{A}(x,x⁽ⁿ⁾)=Σ_{i,j=1}^{M}A_{i,j}(xᵢ−xᵢ⁽ⁿ⁾)(xⱼ−xⱼ⁽ⁿ⁾), (20)

where A_{i,j}=δ_{i,j}. The original five-graded CRA risk levels were used as-is without binarization. The number of k was optimized via LOO CV.

For the x-LR method, the original five-graded CRA risk levels were used as-is without binarization. Upon training, bootstrap resampling was performed for the troubled projects to obtain the same sample size as the healthy projects. The decision threshold was optimized via LOO CV.

For the tw-kNN method, a simple 0-1 weighting was used. Specifically, one of the four groups was selected and the weight for the selected group was turned off, leaving the other weights unchanged as one.

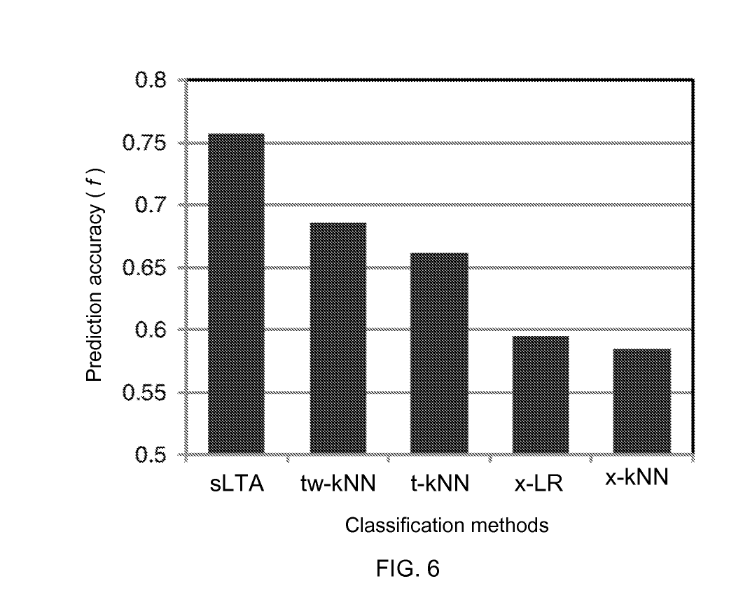

FIG. 6 illustrates a comparison of failure prediction accuracies using various classification methods, in accordance with an embodiment of the present invention. As shown in FIG. 6, the prediction accuracies (f) for the baseline methods are as low as 0.59 (i.e., for x-kNN, f=0.59). By contrast, the sLTA method disclosed herein, along with the tw-kNN and t-kNN methods, show significantly improved accuracies. In this example, sLTA had the highest prediction accuracy (f=0.76).

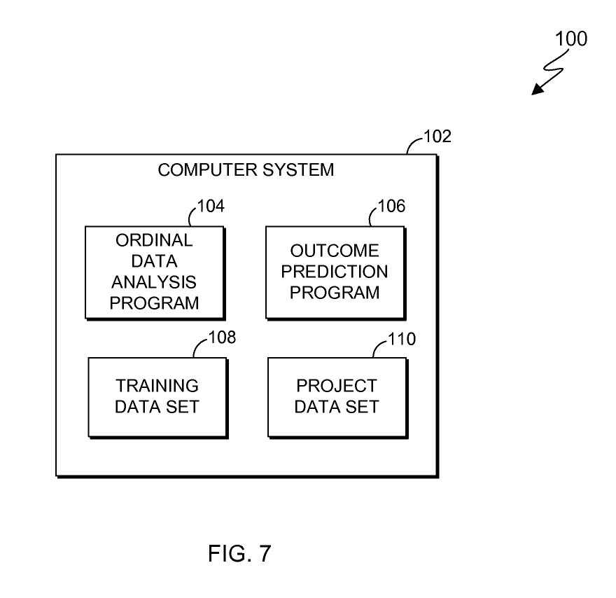

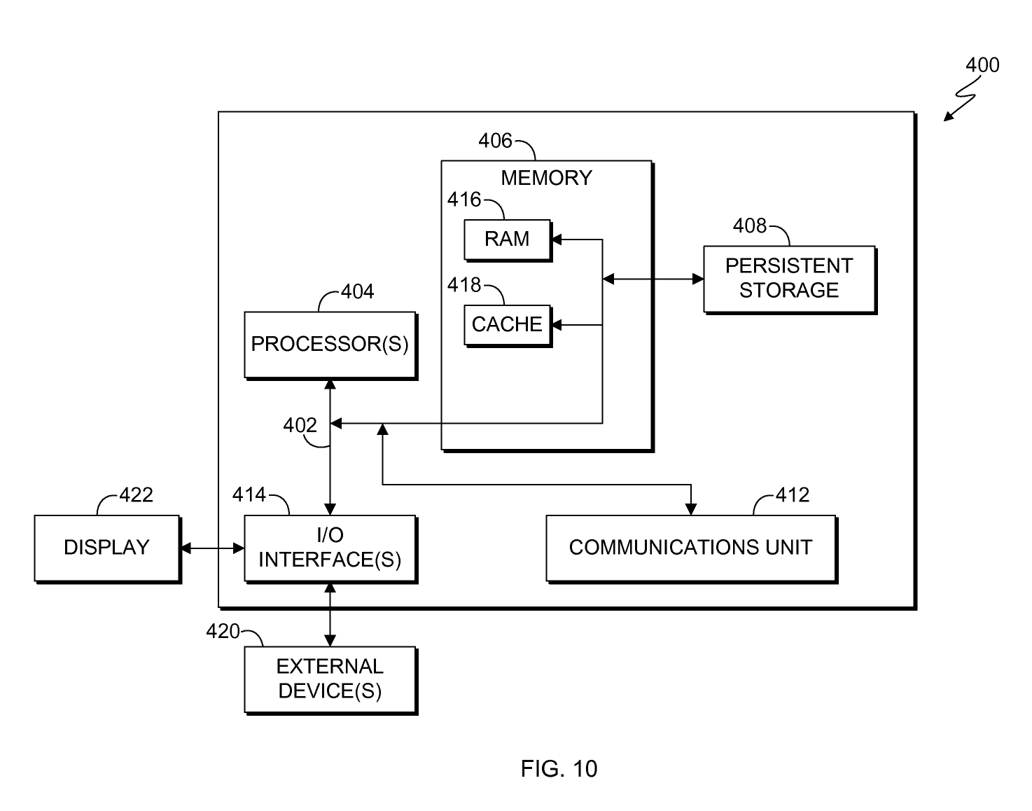

FIG. 7 is a functional block diagram of computing environment 100, in accordance with an embodiment of the present invention. Computing environment 100 includes computer system 102. Computer system 102 can be a desktop computer, laptop computer, specialized computer server, or any other computer system known in the art. In certain embodiments, computer system 102 represents a computer system utilizing clustered computers and components to act as a single pool of seamless resources when accessed through a network (e.g., a local area network (LAN), a wide area network (WAN) such as the Internet, or a combination of the two, including any combination of connections and protocols that will support communications in accordance with a desired embodiment of the invention). For example, such embodiments may be used in data center, cloud computing, storage area network (SAN), and network attached storage (NAS) applications. In certain embodiments, computer system 102 represents a virtual machine. In general, computer system 102 is representative of any electronic device, or combination of electronic devices, capable of executing machine-readable program instructions, as described in greater detail with regard to FIG. 10.

Computer system 102 includes ordinal data analysis (ODA) program 104, outcome prediction program 106, training data set 108, and project data set 110. ODA program 104 analyzes training data set 108 to assess informativeness of ordinal data sets in predicting a measured outcome. In one embodiment, as discussed above, the ordinal data sets include questionnaire items for quality assurance of projects, and ODA program 104 analyzes questionnaire items and answers to construct one or more models that reflect informativeness of those questionnaire items and answers with respect to project health indicators that have been assigned to those projects after a project management review. In general, the ordinal data set can include any suitable desired data, and ODA program 104 can be used to determine usefulness and/or informativeness of the ordinal data set in predicting various measured outcomes.

Outcome prediction program 106 analyzes project data set 110 to predict a measured outcome. In one embodiment, as discussed above, project data set 110 includes one or more of the same question items as training data set 108, but includes answers to those question items that have been made for a future project, prior to performance of that future project. Outcome prediction program 106 can analyze project data set 110 in view of one or more models constructed by ODA program 104 based on training data set 108, in order to predict project health indicators for the future project. Again, in general, the inputted ordinal data sets can include any suitable desired data and outcome prediction program 106 can be used to predict various desired measured outcomes (i.e., pertaining to risk or otherwise).

Training data set 108 includes an ordinal data set that can be analyzed by ODA program 104 and outcome prediction program 106, as discussed above. In one embodiment, training data set 108 includes quality assurance questionnaire items designed to assess levels of risk for various aspects of business projects that have already been undertaken, along with one or more project health indicators for the project. For example, a risk factor of “Lack of awareness of customer requirements” may be encoded into five levels, where 1 represents “no risk”, and 5 represents “exceptionally high risk”. In another example, risk factors can be encoded into two levels, where +1 represents “not at-risk” and −1 represents “at-risk”. Such questionnaires may be provided, for example, as a part of a contract risk management process, in which prior to signing a contract for service delivery, quality assurance experts of the service provider may assess technical and business aspects of the proposed deal such that risks can be mitigated. The one or more project health indicators can reflect, for example, financial, technical, and project management statuses (i.e., outcomes) of the project.

Project data set 110 includes another ordinal data set that can be analyzed by ODA program 104 and outcome prediction program 106, as discussed above. In one embodiment, project data set 110 includes the same quality assurance questionnaire items as training data set 108, but having answers provided for a future business project, as opposed to a plurality of business projects for which evaluators have already provided project health indicators.

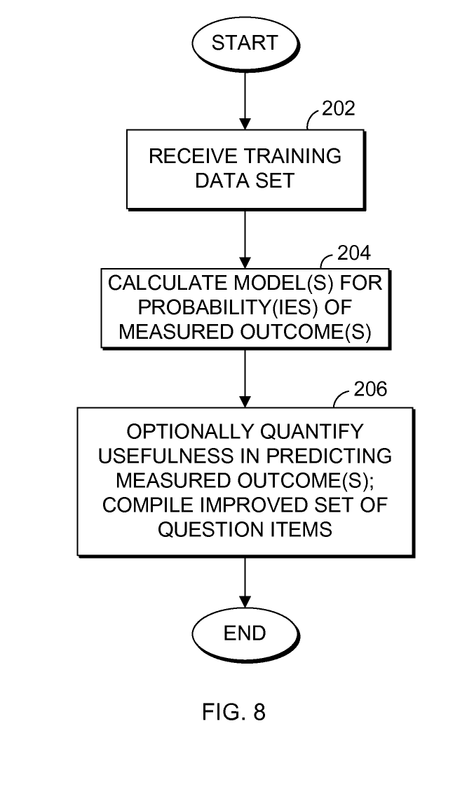

FIG. 8 is a flowchart illustrating operational steps for analyzing usefulness of an ordinal data set in predicting a measured outcome, in accordance with an embodiment of the present invention.

In step 202, ODA program 104 receives training data set 108. In this embodiment, training data set 108 includes quality assurance questionnaire items and answers for business projects that have been undertaken, along with project health indicators for those projects. For example, for a given quality assurance questionnaire, training data set 108 can include several hundred sets of answers to the questionnaire items of that questionnaire for several hundred different projects. In other embodiments, other data sets of different types of ordinal data can be used, and other suitable numbers of data samples can be used, as will be appreciated by those of ordinary skill in the art. For example, ODA program 104 can be used to analyze ordinal data in the context of healthcare QA, employee evaluation, and academic testing. In such other contexts, the term “project”, as used herein, can instead refer generally to whatever person or thing is being assessed by the ordinal data, such as a patient (e.g., in healthcare QA), an employee (e.g., in employee evaluation), or a student (e.g., in academic testing).

In step 204, ODA program 104 calculates one or more models that reflect probabilities of measured outcomes, based on an analysis of training data set 108. In this embodiment, ODA program 104 calculates a model for each questionnaire item according to Equation 2 that reflects the probability of that questionnaire item being answered at-risk (e.g., +1) or not at-risk (e.g., −1), as compared to specified latent failure tendency values. ODA program 104 can also generate item characteristic curves of the calculated probabilities (e.g., plotting P(θ_{g}, aᵢ, bᵢ, cᵢ) and 1−P(θ_{g}, aᵢ, bᵢ, cᵢ)).

In step 206, ODA program 104 optionally quantifies the usefulness (i.e., informativeness) of question items in training data set 108 in predicting measured outcomes, and compiles an improved set of question items. In this embodiment, the usefulness of a question item in predicting a measured outcome can be calculated as a usefulness score, based on divergence between the probability distribution for that questionnaire item being answered at-risk and the probability distribution for that questionnaire item being answered not at-risk, as provided in Equations 15 and 16.

After calculating a usefulness score for each question item in training data set 108, ODA program 104 can compile an improved set of question items that contains only those question items having a usefulness score that satisfies a specified threshold. In this manner, ODA program 104 can construct improved questionnaires that contain question items that are most likely to be informative as to whether a future project will be troubled, which can potentially simply the questionnaire by eliminating question items that are not accurate predictors of project troubles.

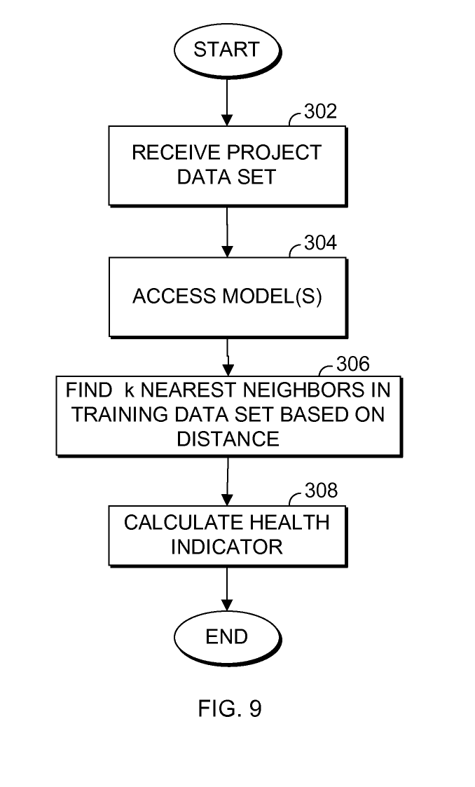

FIG. 9 is a flowchart illustrating operational steps for predicting a measured outcome based on an ordinal data set, in accordance with an embodiment of the present invention.

In step 302, outcome prediction program 106 receives project data set 110. In this embodiment, project data set 110 includes one or more of the same questionnaire items as training data set 108, but having answers provided for a future business project that has not been performed and for which project health indicators have not been provided.

In step 304, outcome prediction program 106 accesses one or more models calculated for training data set 108. In this embodiment, outcome prediction program 106 accesses models calculated by ODA program 104 according to Equation 2 and/or ICCs generated therefrom (e.g., in step 204).

In step 306, outcome prediction program 106 finds k nearest neighbors (i.e., projects) in training data set 108 based on distance. In this embodiment, outcome prediction program 106 finds k nearest neighbors in training data set 108 using Equation 14 and in accordance with the prior discussion thereof. As a result, outcome prediction program 106 finds in training data set 108 one or more projects having questionnaire answer sets that most closely match (i.e., are closest in distance and, therefore, are nearest neighbors) the answer set of the future business project of project data set 110.

In step 308, outcome prediction program 106 calculates a health indicator for the future business project. In this embodiment, outcome prediction program 106 calculates a health indicator that indicates whether the future business project will be troubled using Equation 18 and in accordance with the prior discussion thereof. Stated differently, for the k nearest neighbors identified in step 306, outcome prediction program 106 checks their values of y (e.g., y=+1 for troubled projects, and y=−1 for healthy projects) and calculates a decision score a(x), which considers the proportion of nearest neighbors (i.e., questionnaire answer sets that are most similar to that of the future business project) that are troubled as compared to healthy. If the decision score a(x) satisfies a specified threshold, the future business project is classified as being troubled and is assigned a corresponding health indicator; if the decision score a(x) does not satisfy the specified threshold, the future business project is classified as being healthy and is assigned a corresponding health indicator.

FIG. 10 is a block diagram of internal and external components of a computer system 400, which is representative the computer systems of FIG. 7, in accordance with an embodiment of the present invention. It should be appreciated that FIG. 10 provides only an illustration of one implementation and does not imply any limitations with regard to the environments in which different embodiments may be implemented. In general, the components illustrated in FIG. 10 are representative of any electronic device capable of executing machine-readable program instructions. Examples of computer systems, environments, and/or configurations that may be represented by the components illustrated in FIG. 10 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 400 includes communications fabric 402, which provides for communications between one or more processors 404, memory 406, persistent storage 408, communications unit 412, and one or more input/output (I/O) interfaces 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media. Software (e.g., ODA program 104, outcome prediction program 106, etc.) is stored in persistent storage 408 for execution and/or access by one or more of the respective processors 404 via one or more memories of memory 406.

Persistent storage 408 may include, for example, a plurality of magnetic hard disk drives. Alternatively, or in addition to magnetic hard disk drives, persistent storage 408 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computer-readable storage medium that is also part of persistent storage 408.

Communications unit 412 provides for communications with other computer systems or devices via a network. In this exemplary embodiment, communications unit 412 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to computer system 102 through communications unit 412 (e.g., via the Internet, a local area network or other wide area network). From communications unit 412, the software and data can be loaded onto persistent storage 408.

One or more I/O interfaces 414 allow for input and output of data with other devices that may be connected to computer system 400. For example, I/O interface 414 can provide a connection to one or more external devices 420 such as a keyboard, computer mouse, touch screen, virtual keyboard, touch pad, pointing device, or other human interface devices. External devices 420 can also include portable computer-readable storage media such as, for example, thumb drives, portable optical or magnetic disks, and memory cards. I/O interface 414 also connects to display 422.

Display 422 provides a mechanism to display data to a user and can be, for example, a computer monitor. Display 422 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving, by one or more computer processors, a first ordinal data set;
analyzing, by one or more computer processors, the first ordinal data set to construct one or more models that describe informativeness of data in the first ordinal data set in predicting a first measured outcome of one or more projects associated with the first ordinal data set;
receiving, by one or more computer processors, a second ordinal data set; and
predicting, by one or more computer processors, a second measured outcome of a project associated with the second ordinal data set based, at least in part, on the one or more models.

2. The method of claim 1, wherein the first ordinal data set comprises a questionnaire having a plurality of question items and a first set of answers to the plurality of question items.

3. The method of claim 2, wherein the second ordinal data set comprises the questionnaire having the plurality of question items and a second set of answers to the plurality of question items.

4. The method of claim 3, further comprising:
calculating, by one or more computer processors, an informativeness score for each of the plurality of question items of the first ordinal data set; and
generating, by one or more computer processors, a third ordinal data set comprising question items of the plurality of question items of the first ordinal data set that have an informativeness score that satisfies a specified threshold.

5. The method of claim 1, wherein the one or more models describe informativeness of question items in the first ordinal data set in predicting whether the one or more projects associated with the first ordinal data set will be given a particular project health rating.

6. The method of claim 5, wherein the particular project health rating indicates whether the one or more projects associated with the first ordinal data set will be troubled.

7. The method of claim 1, wherein the one or more models include an item characteristic curve of non-Gaussian distributions of probabilities of a question item being answered a particular way, as a function of a latent failure tendency of a project.

8. A computer program product comprising:
one or more computer readable storage media and program instructions stored on the one or more computer readable storage media, the program instructions comprising:
program instructions to receive a first ordinal data set;
program instructions to analyze the first ordinal data set to construct one or more models that describe informativeness of data in the first ordinal data set in predicting a first measured outcome of one or more projects associated with the first ordinal data set;
program instructions to receive a second ordinal data set; and
program instructions to predict a second measured outcome of a project associated with the second ordinal data set based, at least in part, on the one or more models.

9. The computer program product of claim 8, wherein the first ordinal data set comprises a questionnaire having a plurality of question items and a first set of answers to the plurality of question items.

10. The computer program product of claim 9, wherein the second ordinal data set comprises the questionnaire having the plurality of question items and a second set of answers to the plurality of question items.

11. The computer program product of claim 10, wherein the program instructions stored on the one or more computer readable storage media further comprise:
program instructions to calculate an informativeness score for each of the plurality of question items of the first ordinal data set; and
program instructions to generate a third ordinal data set comprising question items of the plurality of question items of the first ordinal data set that have an informativeness score that satisfies a specified threshold.

12. The computer program product of claim 8, wherein the one or more models describe informativeness of question items in the first ordinal data set in predicting whether the one or more projects associated with the first ordinal data set will be given a particular project health rating.

13. The computer program product of claim 12, wherein the particular project health rating indicates whether the one or more projects associated with the first ordinal data set will be troubled.

14. The computer program product of claim 8, wherein the one or more models include an item characteristic curve of non-Gaussian distributions of probabilities of a question item being answered a particular way, as a function of a latent failure tendency of a project.

15. A computer system comprising:
one or more computer processors;
one or more computer readable storage media; and
program instructions stored on the one or more computer readable storage media for execution by at least one of the one or more processors, the program instructions comprising:
program instructions to receive a first ordinal data set;
program instructions to analyze the first ordinal data set to construct one or more models that describe informativeness of data in the first ordinal data set in predicting a first measured outcome of one or more projects associated with the first ordinal data set;
program instructions to receive a second ordinal data set; and
program instructions to predict a second measured outcome of a project associated with the second ordinal data set based, at least in part, on the one or more models.

16. The computer system of claim 15, wherein the first ordinal data set comprises a questionnaire having a plurality of question items and a first set of answers to the plurality of question items.

17. The computer system of claim 16, wherein the second ordinal data set comprises the questionnaire having the plurality of question items and a second set of answers to the plurality of question items.

18. The computer system of claim 17, wherein the program instructions stored on the one or more computer readable storage media further comprise:
program instructions to calculate an informativeness score for each of the plurality of question items of the first ordinal data set; and
program instructions to generate a third ordinal data set comprising question items of the plurality of question items of the first ordinal data set that have an informativeness score that satisfies a specified threshold.

19. The computer system of claim 15, wherein the one or more models describe informativeness of question items in the first ordinal data set in predicting whether the one or more projects associated with the first ordinal data set will be given a particular project health rating.

20. The computer system of claim 15, wherein the one or more models include an item characteristic curve of non-Gaussian distributions of probabilities of a question item being answered a particular way, as a function of a latent failure tendency of a project.
